(19) United States
(12) Patent Application Publication
(10) Pub. No.: US 2022/0129490 A1
(43) Pub. Date: Apr. 28, 2022

(54) PREDICTION METHOD BASED ON UNSTRUCTURED DATA

(71) Applicant: National Taiwan University, Taipei (TW)

(72) Inventors: Xin-Xue LIN, Taipei (TW); Phone LIN, Taipei (TW)

(73) Assignee: National Taiwan University, Taipei (TW)

(21) Appl. No.: 17/509,087

(22) Filed: Oct. 25, 2021

(30) Foreign Application Priority Data
Oct. 26, 2020 (TW) 109137101

(51) Int. Cl. G06F 16/335; G06F 16/33; G06F 40/40; G06N 20/00

(52) U.S. Cl. CPC G06F 16/337; G06N 20/00; G06F 40/40; G06F 16/3347

(57) ABSTRACT

The present invention discloses a prediction method based on unstructured data, applied in a prediction system comprising an analyzing module and a model-building module to predict future behaviors of a user. The prediction method comprises steps of: with the analyzing module, analyzing a recording file with a natural language processing algorithm to generate at least one feature vector, wherein the recording file is related to a subject behavior in a predetermined observation period, at least one record in a form of unstructured data is stored therein, and the record comprises a time stamp and a recording text; and with the model-building module, using a surprised machine learning algorithm building a model with information corresponding to the feature vector as input for predicting future behaviors of a user, wherein the record is one of query record of domain name system, transaction record of automated teller machine, transaction record of structured query language and literal record.

### FIELD OF THE INVENTION

The present invention generally relates to a prediction method, and specifically, relates to a prediction method based on unstructured data building a model for prediction.

### BACKGROUND OF THE INVENTION

Most information and knowledge, as high as 90% among all, are buried in unstructured data according to statistics. However, because unstructured data cannot be defined with a fixed format inherently, nor even digitalized, their usage is limited despite the fact that they possess tremendous valuable information. In view of this, one of the goals in information industry is to properly processing unstructured data without losing excessive raw data, so as to extracting information and knowledge for use effectively.

### SUMMARY OF THE INVENTION

One aspect of the present invention is to provide a prediction method based on unstructured data which can use unstructured data as raw data to build a model. According to one embodiment of the invention, the prediction method may build a model with information corresponding to at least one feature vector, generated from analyzing a recording file with a natural language processing (NLP) algorithm, as input for predicting future behaviors of a user. As such, raw data may not be excessively lost, and features may not be selected by human, so as to lower development cost effectively.

In one aspect of the invention, an embodiment of the invention is provided that a prediction method based on unstructured data, applied in a prediction system comprising an analyzing module and a model-building module to predict future behaviors of a user, comprising steps of: with the analyzing module, analyzing a recording file with a NLP algorithm to generate at least one feature vector, wherein the recording file is related to a subject behavior in a predetermined observation period, at least one record in a form of unstructured data is stored in the recording file, and the at least one record comprises a time stamp and a recording text; and with the model-building module, using a surprised machine learning algorithm building a model with information corresponding to the at least one feature vector as input for predicting the future behaviors of the user, wherein the at least one record is one of query record of domain name system (DNS), transaction record of automated teller machine (ATM), transaction record of structured query language (SQL) and literal record.

### BRIEF DESCRIPTION OF THE DRAWINGS

Various objects and advantages of the present invention will be more readily understood from the following detailed description when read in conjunction with the appended drawing, in which:

FIG. 1 shows a prediction system according to an embodiment of the invention which is adapt to apply a prediction method based on unstructured data as shown in FIG. 2;

FIG. 2 shows a prediction method based on unstructured data according to an embodiment of the invention;

FIG. 3 shows an example implementing a record with a query record of domain name system (DNS) for the steps S2 and S3 according to an embodiment of the present invention.

### DESCRIPTION OF EMBODIMENTS OF THE INVENTION

To understand the present disclosure and its advantages, reference is now made to the following description taken in conjunction with the accompanying drawings, in which like reference numbers indicate like features. Persons having ordinary skills in the art will understand other varieties for implementing example embodiments, including those described herein. The drawings are not limited to a specific scale, and similar reference numbers are used for representing similar elements. As used in the disclosures and the appended claims, the terms “embodiment,” “example embodiment,” and “present embodiment” do not necessarily refer to a single embodiment, although it may, and various example embodiments may be readily combined and interchanged, without departing from the scope or spirit of the present disclosure. Furthermore, the terminology as used herein is for the purpose of describing example embodiments only and is not intended to be a limitation of the disclosure. In this respect, as used herein, the term “in” may include “in,” “on,” and the terms “a,” “an,” and “the” may include singular and plural references. Furthermore, as used herein, the term “by” may also mean “from,” depending on the context. Furthermore, as used herein, the term “if” may also mean “when” or “upon,” depending on the context. Furthermore, as used herein, the words “and/or” may refer to and encompass any and all possible combinations of one or more of the associated listed items.

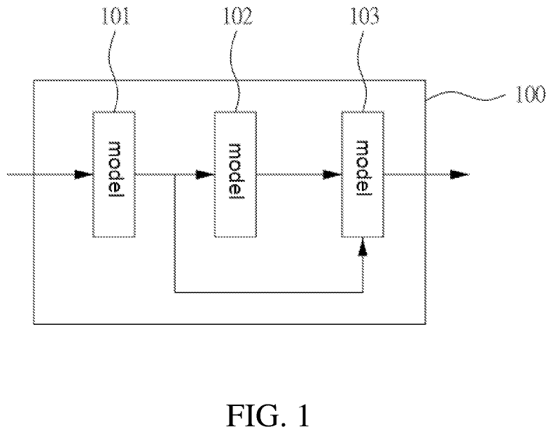

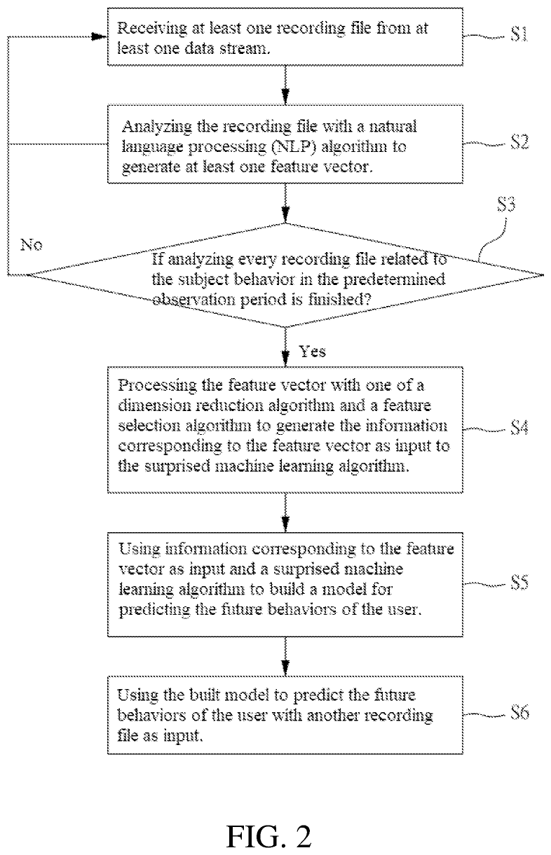

The present invention discloses various examples of a prediction method based on unstructured data. Referring to FIGS. 1 and 2, FIG. 1 shows a prediction system according to an embodiment of the invention which is adapt to apply a prediction method based on unstructured data as shown in FIG. 2, and FIG. 2 shows a prediction method based on unstructured data according to an embodiment of the invention. Please note that the prediction system of the present embodiment is only one of the examples, and the prediction method based on unstructured data is not limited to the exemplary prediction system. The prediction system 100 comprises an analyzing module 101, a model-building module 102 and a prediction module 103. The analyzing module 101 may couple to the model-building module 102 and the prediction module 103, and the model-building module 102 may couple to the prediction module 103.

At first, in a step S1, the analyzing module 101 may receive at least one recording file from at least one data stream. The recording file may preferably be related to a subject behavior in a predetermined observation period, for example, the recording file may be a log file of activity history, generated with a specific system, recording a user performing the subject behavior. At least one record in a form of unstructured data may be stored in the recording file. The format of the record may be unlimited and lack of unity; however, each of the record may at least comprise a time stamp and a recording text. The time stamp may correspond to the recording text. The type of the record may not be limited but depend on the application of the prediction method based on unstructured data. For example, the record may be one of query record of domain name system (DNS), transaction record of automated teller machine (ATM), transaction record of structured query language (SQL) and literal record. Given that past behaviors may relate to future behaviors in general, in the present embodiment, the recording file may be related to the subject behavior, such as surfing the Internet, in a past predetermined observation period, and the record may be implemented as query record of DNS recording the subject behavior, collected by a system of a telecommunication business owner for example. The query record of DNS may comprise at least one of A, AAAA, AFSDB, APL, CAA, CDNSKEY, CDS, CERT, CNAME, DHCID, DLV, DNAME, DNSKEY, DS, HIP, IPSECKEY, KEY, LOC record, MX record, NAPTR record, NS, NSEC, NSEC3, NSEC3PARAM, PTR, RRSIG, RP, SIG, SOA, SPF, SRV record, SSHFP, TA, TKEY record, TSIG, TXT, URI, *, AXFR, IXFR, OPT. As such, domain name and time of the website page browsed may be recorded.

Then, in a step S2, the analyzing module 101 may analyze the recording file with a natural language processing (NLP) algorithm to generate at least one feature vector. Specifically, when analyzing with NLP algorithm, the analyzing module 101 may view the recording text of each record in the form of unstructured data in the recording file as word of the NLP algorithm, and view the whole recording text of all record(s) of the same user in the form of unstructured data in a predetermined period in the recording file as document of the NLP algorithm. Then, each of the words may be transmitted to one of the at least one feature vector. Here, the NLP algorithm may comprise term frequency-inverse document frequency (TF-IDF) algorithm. Each of the feature vector(s) may represent an importance of the recording text in the recording file in a predetermined period.

Then, in a step S3, the analyzing module 101 may determine if analyzing every recording file related to the subject behavior in the predetermined observation period is finished. When determining that analyzing every recording file related to the subject behavior in the predetermined observation period is not finished, the steps S1 and/or S2 may be repeated to receive other recording file(s) and analyzing the recording file(s) with the NLP algorithm to generate feature vector(s). However, please note that collecting, receiving or analyzing all the recording files may be one-time or multiple-times performed in either specific or nonspecific time. In another embodiment, one-time performing the steps S1, S2 may finish collecting, receiving or analyzing all the recording files without performing the step S3.

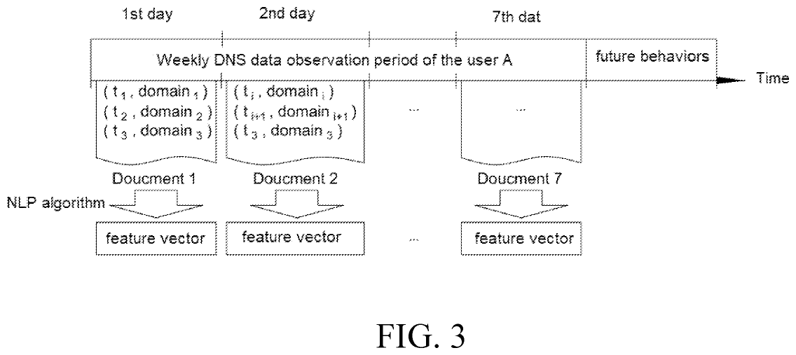

Referring to FIG. 3 which shows an example implementing a record with a query record of DNS for the steps S2 and S3 according to an embodiment of the present invention, the predetermined observation period may be seven days and the predetermined period may be one day for example. The analyzing module 101 may view the recording text (tₙ, domainₙ) as words and the whole of each recording text (tₙ, domainₙ), n=1−N, of the same user in one day as a document. Then, the analyzing module 101 may calculate with the NLP algorithm to generate the feature vector corresponding to the document. Because the recording text of each record comprises website pate domain name browsed by the user, a set of feature vector processed with the NLP algorithm may represent the importance of each domain name. The analysis may be performed every day in seven days.

Then, before building the model for prediction according to the feature vector, a step S4 may be performed in the present embodiment. The analyzing module 101 may process the feature vector with one of a dimension reduction algorithm and a feature selection algorithm to generate the information corresponding to the feature vector as input to the surprised machine learning algorithm. The dimension reduction algorithm may decrease errors due to redundant information and raise precision of identification because it assists in reducing data quantity, maintain data identity or targeting inherent structure feature in the data as much as possible. Here, the dimension reduction algorithm may comprise one of principal component analysis (PCA) algorithm, latent semantic analysis (LSA) algorithm and pitch detection dlgorithm (PDA) algorithm. The feature selection algorithm may eliminate irrelevant or redundant feature(s) so as to reduce the number of the features, raise precision of the model or decrease execution time. Here, the feature selection algorithm may be one of chi-square tests algorithm and Gini importance algorithm.

Then, in a step S5, the model-building module 102 may use information corresponding to the feature vector, such as the resultant information from the feature vector generated in the step S2 and then processed in the step S3 or other processing technology, as input and a surprised machine learning algorithm to build a model for predicting the future behaviors of the user. In the present embodiment, a word formed with a series of status or letter may be used to build the model in the prediction module 103, and the surprised machine learning algorithm may comprise one of logistic regression algorithm and random forest algorithm.

Then, in a step S6, the prediction module 103 may use the built model to predict the future behaviors of the user with another recording file as input. Here, the prediction result may be implemented as a possibility of occurrence of one of the future behaviors of the user, and the recording file may be received through at least one data stream. For instance, the information corresponding to the feature vector may be used to build the model analyzing correlation of traveling in a period of the user from the Internet surfing record for information of traveling, hotel, transportation, etc. As such, a telecommunication business owner may provide advertisement related to traveling to the user with great precision. Therefore, according to the prediction method based on unstructured data of the present embodiment, recording file in the form of unstructured data may be used as raw data to build the model, the recording file may be analyzed with the NLP algorithm to generate the feature vector which may be used to build the model for predicting the future behaviors of the user. As such, raw data may not be excessively lost, and features may not be selected by human, so as to lower development cost effectively.

It is to be understood that these embodiments are not meant as limitations of the invention but merely exemplary descriptions of the invention with regard to certain specific embodiments. Indeed, different adaptations may be apparent to those skilled in the art without departing from the scope of the annexed claims. For instance, it is possible to add bus buffers on a specific data bus if it is necessary. Moreover, it is still possible to have a plurality of bus buffers cascaded in series.

What is claimed is:

1. A prediction method based on unstructured data, applied in a prediction system comprising an analyzing module and a model-building module to predict future behaviors of a user, comprising steps of:
with the analyzing module, analyzing a recording file with a natural language processing (NLP) algorithm to generate at least one feature vector, wherein the recording file is related to a subject behavior in a predetermined observation period, at least one record in a form of unstructured data is stored in the recording file, and the at least one record comprises a time stamp and a recording text; and
with the model-building module, using a surprised machine learning algorithm building a model with information corresponding to the at least one feature vector as input for predicting the future behaviors of the user, wherein the at least one record is one of query record of domain name system (DNS), transaction record of automated teller machine (ATM), transaction record of structured query language (SQL) and literal record.

2. The prediction method based on unstructured data according to claim 1, wherein the NLP algorithm comprises a term frequency-inverse document frequency (TF-IDF) algorithm.

3. The prediction method based on unstructured data according to claim 1, wherein the step of with the analyzing module, analyzing a recording file with a NLP algorithm to generate at least one feature vector further comprises:
analyzing with the recording file as document of the NLP algorithm and each of the at least one record as word of the NLP algorithm to transform each of the word to one of the at least one feature vector.

4. The prediction method based on unstructured data according to claim 1, wherein the at least one feature vector represents an importance of the recording text in the recording file.

5. The prediction method based on unstructured data according to claim 1, further comprising:
processing the at least one feature vector with one of a dimension reduction algorithm and a feature selection algorithm to generate the information corresponding to the at least one feature vector as input to the surprised machine learning algorithm.

6. The prediction method based on unstructured data according to claim 1, wherein the dimension reduction algorithm comprises one of principal component analysis (PCA) algorithm, latent semantic analysis (LSA) algorithm and pitch detection algorithm (PDA).

7. The prediction method based on unstructured data according to claim 5, wherein the feature selection algorithm comprises one of chi-square tests algorithm and Gini importance algorithm.

8. The prediction method based on unstructured data according to claim 1, wherein the surprised machine learning algorithm comprises one of logistic regression algorithm and random forest algorithm.

9. The prediction method based on unstructured data according to claim 1, further comprising:
repeating the step of analyzing a recording file with a natural language processing algorithm to generate at least one feature vector when determining that analyzing every recording file related to the subject behavior in the predetermined observation period is not finished with the analyzing module.

10. The prediction method based on unstructured data according to claim 1, further comprising:
with a prediction module of the prediction system, using the built model to predict a possibility of occurrence of one of the future behaviors of the user.
